(19) United States
(12) Patent Application Publication
(10) Pub. No.: US 2008/0059490 A1
(43) Pub. Date: Mar. 6, 2008

(54) Design time

(76) Inventors: Juergen Sattler, Wiesloch (DE); Joachim Gaffga, Wiesloch (DE); Werner Wolf, Wiesloch (DE); Robert Viehmann, Waghausl (DE); Frank Markert, Grossostheim (DE)

Correspondence Address: SCHWEGMAN, LUNDBERG & WOESSNER/SAP, P.O. BOX 2938, MINNEAPOLIS, MN, 55402, US

(21) Appl. No.: 11/512,884

(22) Filed: Aug. 29, 2006

(51) Int. Cl. G06F 17/00

(52) U.S. Cl. 707/100

(57) ABSTRACT

The present subject mater relates to configuration of computer applications and, more particularly, to design time application configuration. Various embodiments provide systems, methods, and software to store, in a memory device, a scoping input database, wherein the scoping input database holds one or more customer profiles, and store, in the memory device, a content data store. Some embodiments further store, in the memory device, an adaptation catalog, wherein the adaptation catalog links content stored in the content data store to possible customer profiles stored in the scoping input database. Some such embodiments execute one or more configuration processes, wherein the one or more configuration processes execute to instantiate an application configuration in a workspace area of the memory device, wherein the application configuration includes content selected as a function of a customer profile from the scoping input database and the adaptation catalog.

### TECHNICAL FIELD

The present subject mater relates to configuration of computer applications and, more particularly, to design time application configuration.

### BACKGROUND INFORMATION

Configuring software applications can be a difficult task. The difficulty in configuring such systems grows in complexity as the size of the software application increases. An example of a complex software application to configure is an enterprise resource planning (“ERP”) application. Efforts to configure such applications often involve a large number of employees and even consultants. These efforts may string out over many months, and even multiple years. Further, modifying a large software application configuration or upgrading such an application can, depending on the size of the configuration modification project or scope of the application upgrade, may involve equal amounts of time and cost as an initial implementation.

A major cause for the complexity of modifying and upgrading such software applications is that configuration settings are often stored in configuration tables. The configurations settings in these tables typically do not provide any context of what the configuration settings are for, other than by reference to a manual or from the experience of person modifying the setting. Thus, modifying application configurations often falls upon highly skilled and experienced individuals, such as consultants. However, such individuals or consultants may not have the intrinsic knowledge of an organization that utilizes the application. This may cause the configuration efforts to take additional time and cost more.

### BRIEF DESCRIPTION OF THE DRAWINGS

FIG. 1 is a block diagram of a system according to an example embodiment.

FIG. 2A is a block diagram of a system according to an example embodiment.

FIG. 2B is a block diagram of a system according to an example embodiment.

FIG. 3 is a block diagram of a system according to an example embodiment.

FIG. 4 is a flow diagram of a method according to an example embodiment.

FIG. 5 is a block diagram of a system according to an example embodiment.

### DETAILED DESCRIPTION

Various embodiments described herein provide systems, methods, and software to reduce the complexity of configuring software applications, such as large-scale enterprise resource planning (“ERP”) applications. Some embodiments reduce the complexity of configuring such application by providing tools that place configuration setting decisions in a context where the decision-making is easier. Further, some embodiments may provide tools to input application configuration preferences that, when received, are utilized by one or more processes to make configuration decisions that are consistent across the application under configuration.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, electrical, or other changes may be made without departing from the scope of the inventive subject matter. Such embodiments of the inventive subject matter may be referred to, individually and/or collectively, in the present application by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described in the present application are implemented in hardware, software or a combination of software and hardware in one or more embodiments. The software comprises computer executable instructions stored on computer readable media such as memory or other type of storage devices. The term “computer readable media” is also used to represent carrier waves on which the software is transmitted. Further, such functions correspond to modules, which may be one or more, or a combination of, software, hardware, or firmware. Multiple functions are performed in one or more modules as desired, and the embodiments described are merely examples. The software may be executed on a digital signal processor, ASIC, microprocessor, or other type of processor operating on a system, such as a personal computer, server, a router, or other device capable of processing data including devices interconnected by a network.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

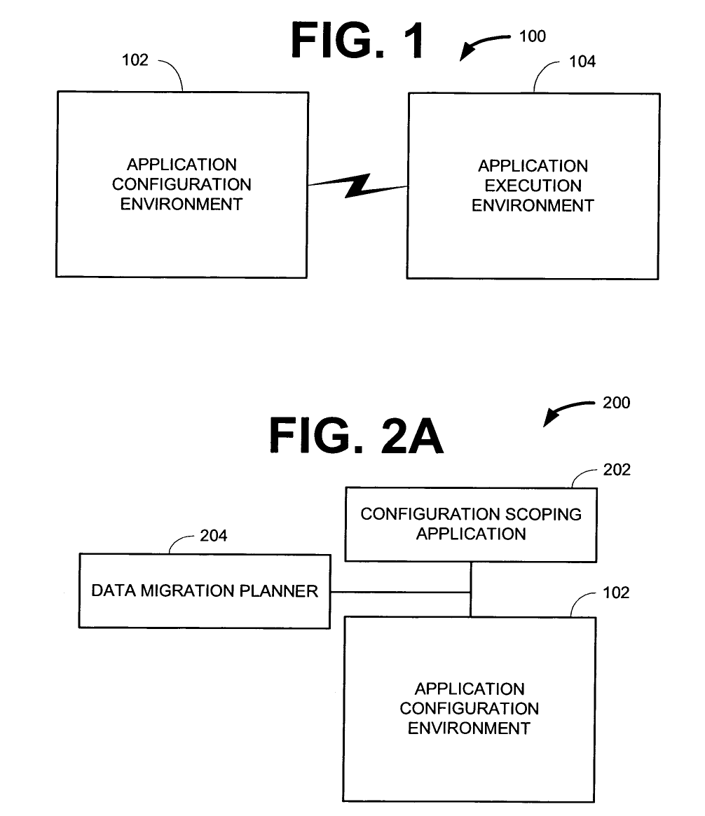

FIG. 1 is a block diagram of a system 100 according to an example embodiment. The system 100 includes an application configuration environment 102 and an application execution environment 104.

The application configuration environment 102 is a system 100 environment within which an application can be configured. However, the application will, or does, execute within the application execution environment 104. In some embodiments, this arrangement of the application configuration environment 102 and the application execution environment 104 separates the configuration of an application from the environment within which it executes. When an application configuration has been established, all or part of the configuration can then be deployed to the application execution environment 104. This deployment can occur to one or more separate instance of the application in the application execution environment 104. Although only a single application execution environment 104 is illustrated, multiple application execution environments 104 can exist, and the deployment can be made to one or more of the multiple application execution environments 104.

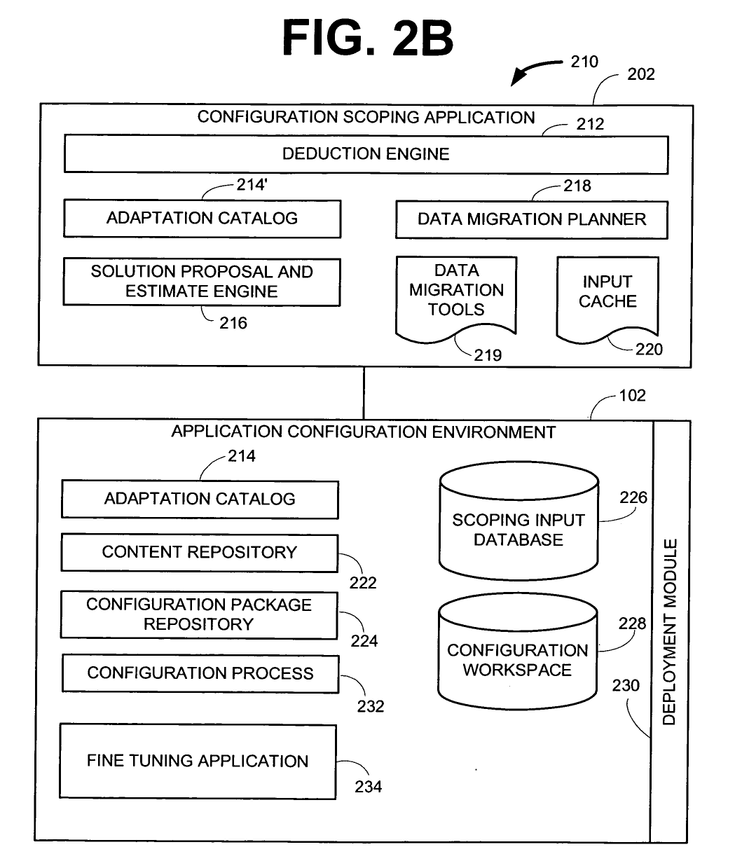

FIG. 2A is a block diagram of a system 200 according to an example embodiment. The system 200 includes a configuration scoping application 202, a data migration planner application 204, and the application configuration environment 102.

The configuration scoping application 202 typically is a software tool that executes on a computing device, such as a portable computer, on a same computing device within which the application configuration environment 102 exists, or on another computing device that can be communicatively coupled to the application configuration environment 102.

The configuration scoping application 202, when executed, typically presents a set of scoping questions to a user. The scoping questions ma be linked to one of many adaptation catalog entries. The adaptation catalog entries may include a representation of all of the solution capabilities of an application to be configured, and eventually executed. In some embodiments, the solution capabilities are hierarchically divided into areas, packages, topics, and options. There may be multiple areas, and each area may have multiple packages. Each package may have multiple topics, and each topic may have multiple options.

In some embodiments, such as in an example embodiment where the application to be configured is an ERP application, the adaptation catalog may provide in the area Sales, a package Customer Order Management that contains the topics Sales Order Quote, Sales Order, Sales Order Analysis, and others. On that level, one or more options typically exist such as Approval Processing.

In the configuration scoping application 202, as stated above, scoping question may be linked to an adaptation catalog entry. An adaptation catalog entry further includes a rule. These rules typically model dependencies between the areas, packages, topics, and options and corresponding solution capabilities of the application. A rule can may specify required inclusion or exclusion of other areas, packages, topics, or options, or may require specification of further areas, packages, topics, or options. A rule may also specify a recommendation or default area, package, topic, or option.

For example, a first example scoping question, “What is the primary focus of your business?” may have three possible answers including “Sales,” “Service,” and “Logistics.” Such a first scoping question typically is aimed at identifying an area of business in which the application is going to be used. Answering “Sales” typically tells the configuration scoping application 202 that the area is “Sales” and a rule tied to the adaptation catalog entry for “Sales” specifies dependencies with packages, topics, and options and the corresponding solution capabilities of the application necessary or optional in using the application in a sales business. Such a rule can also specify that other packages, topics, and options and the corresponding solution capabilities be excluded.

Thus, when a user answers scoping questions, the configuration of the application is being performed. Further, when a question is answered that is associated with an adaptation catalog entry having a rule that excludes another area, package, topic, or option, that rule may be applied to eliminate questions from consideration. Conversely, when a question is answered that is associated with an adaptation catalog entry having a rule that requires another area, package, topic, or option, that same rule may be applied to determine a next question, or group of questions, to ask a user. However, in the event that a question is not answered that is linked to a rule providing defaults, the question may be skipped without adversely affecting the application configuration.

In some embodiments, such as the embodiment of the system 200, the scoping questions further include a group of questions that request information regarding legacy systems to be replaced or augmented by an application. This group of questions requests and receives input through one or more user interfaces of the configuration scoping application 202. The answers to these questions identify systems, applications operating the systems, and data stores, such as databases, file storage, and other data storage mechanisms, that hold data on the systems that is accessed by the applications. In some embodiments, the questions further receive data necessary for connecting to the data stores. This information, once obtained, is made available to the data migration planner 204, which determines, and provides as output, a data migration plan to move, copy, or integrate data from legacy applications and data stores to the new application.

FIG. 2B is a block diagram of a system 210 according to an example embodiment. The system 210 includes the configuration scoping application 202 and the application configuration environment 102.

The configuration scoping application 202, in some embodiments, may include a deduction engine 212 and an adaptation catalog 214′. In some embodiments, the configuration scoping application 202 may further include a solution proposal and estimate engine 216, a data migration planner 218, data migration tools 219, and an input cache 220.

The application configuration environment 102, in some embodiments, may include an adaptation catalog 214, a content repository 222, and a configuration package repository 224. In some such embodiments, the application configuration environment 102 typically further include a scoping input database 226, a configuration workspace 118, a deployment module 230, a configuration process 232, and a fine tuning application 234.

The adaptation catalog 214 may include a representation of all of the solution capabilities of an application to be configured, and eventually executed. Each capability of an application to be configured is identified in an adaptation catalog 214 entry. The adaptation catalog 214 entries each may be identified as an area, package, topic, or option and may be organized in a hierarchy with a child identifying the parent. An example hierarchy is a “General Ledger” capability, which in some embodiments typically is a package having two topics, “cash based” and “accrual based” which are two application capabilities within the “General Ledger” capability. In some embodiments, the adaptation catalog 214′ entries may be encoded in a markup language, such as eXtensible Markup Language (“XML”), or by another proprietary standard or open standards based encoding standard.

The adaptation catalog 214 entries may further include scoping questions directed toward obtaining scoping information to determine what areas, packages, topics, and options are relevant to the user's needs. Additionally, the adaptation catalog entries typically include rules, the application of which can require inclusion or exclusion, or specify default inclusion or exclusion, of certain other areas, packages, topics, and options. Thus, because the areas, packages, topics, and options correlate to application capabilities, the inclusion, exclusion, and defaulting specifies what capabilities will be enabled and disabled in the application when deployed.

In some embodiments, rules and entries in the adaptation catalog can be linked to a configuration package that exists in the configuration package repository 224. A configuration package includes one or more configuration settings that enable or disable functionality of the application when deployed.

In one embodiment, the rules may be applied by the deduction engine 212 of the configuration scoping application 202. The configuration scoping application 202 typically presents a user interface to a user that requests answers to questions. The questions asked via the user interface are identified by the deduction engine 212 based on the adaptation catalog 214′. The adaptation catalog 214′ is typically a copy of the adaptation catalog 214 of the application configuration environment 102. When an answer is received, the answer may be stored in the input cache 220 of the configuration scoping application 202. The deduction engine 212 then typically applies the rule associated with the adaptation catalog 214′ entry of the question asked to the received answer. Through the application of the rule, in view of answers already received and rules already applied, the deduction engine 212 may be configured to identify a next question to ask. The identified question typically is then presented to the user through the user interface. This process may be configured to continue until either all of the questions have been asked or the user is out of time. If questions remain that have not been answered, the process can be continued at a later time or rules specifying default areas, packages, topics, and options in order to supply enough information to allow deployment of the application in a functional form.

In some embodiments, the configuration scoping application 207 further includes a data migration planner 218. In such embodiments, one or more additional scoping questions typically can be asked. These additional scoping questions may be directed toward obtaining information from the user about legacy systems and how data is stored within them. In some embodiments, the questions simply ask what systems are currently in use. In other embodiments, the questions are more detailed to obtain information such as what type of database a system is utilizing and what type of customization has been made or custom systems developed. In some embodiments, the scoping questions request information to identify one or more of data source types, data source connectivity information, location of certain data items within a data source, data item types, and information describing one or more data items. The data migration planner 218 typically uses the answers to these additional questions to propose a data migration plan to the new application.

The data migration planner 218, in some embodiments, may evaluate the answers to the scoping questions to identify legacy systems utilized and how the data is stored. The data migration planner 218 may also evaluates the scoping question answers to identify what data is needed, and in what form, in an application to be deployed, or otherwise proposed. The data migration planner 218 then typically makes a data migration plan recommendation utilizing one or more data migration tools 219. A copy of the data migration plan may be stored in the configuration workspace 228 or other data storage location accessible within or to the application configuration environment 102.

The data migration tools 219, in some embodiments, typically include a representation of one or more tools that may be utilized to migrate data from a legacy application to the new application. Such tools may include legacy application plugins that execute within a legacy system to move or copy data. Some tools also include a data migration process recommendation for extraction of files from a legacy system and uploading to the files to the data stores of the new application. Some other tools include integration tools that operate between a legacy application and the new application to facilitate sharing of data between the two applications. Other tools and tool types are contemplated as well. Such other tools typically include tools developed by third parties that leverage an open architecture of the system 210 to facilitate data migration and integration between a legacy application and the new application.

In some embodiments, the configuration scoping application 202 includes a solution proposal and estimate engine 216. The solution proposal and estimate engine 216 may be used in a sales situation. For example, if a sales person is discussing with a sales lead what a certain application product can do for the sales lead, the sales person typically can utilize the configuration scoping application 202 to obtain information about the needs of the sales lead via the scoping questions. The scoping question answers may then be utilized by the solution proposal and estimate engine 216 to make an initial determination of what will be involved if the sales lead decides to purchase the application. The solution proposal and estimate engine 216 normally is configured to output information for the sales lead to make several determinations, such as the size of effort necessary to implement or transition to the application from legacy system, the cost involved, and cost. In some embodiments, the output of the solution proposal and estimate engine 216 outputs one or more of an implementation cost estimate, an application solution proposal, and a recommended project roadmap. In some embodiments, the solution proposal and estimate engine 216 outputs a proposal for one or more other options, application descriptions, sales literature, benefit statements of using the application, and addition documents, such as a proposal of key performance indicators the application can monitor to assist in managing the application or enterprise of the sales lead.

After the scoping question have been answered, the answers, and any other information obtained from a sales lead or other user of the configuration scoping application 202, the information typically is uploaded to the application configuration environment 102. However, in embodiments, where the configuration scoping application 202 executes on the same computing device as the application configuration environment 202, the scoping question answers and other information may be stored directly to the application configuration environment 102.

When the configuration question answers and other information is uploaded, or otherwise stored to the application environment 102, the scoping question answers are stored to the scoping input database 226. The scoping question answers, in some instances, will be referred to interchangeably as the “scoping information.”

After the scoping information is within the scoping input database 226, the configuration process 232 may execute to begin configuring an application in the configuration workspace 228. Although the configuration process 232 is illustrated within the application configuration environment 102, the configuration process 232 may be a standalone application.

The configuration workspace 228 typically includes a set of configuration tables that mirrors, at least in part, the configuration tables of the application under configuration. However, the configuration process 232, in some embodiments, may generate the configuration tables in the configuration workspace 228 as an initial step in performing an application configuration, if needed.

In some embodiments, the scoping input typically identifies a type of the application under configuration. In such instances, the application type identification informs the configuration process 232 of what configuration tables to instantiate, if needed, and which configuration tables to populate with data. This allows the configuration process 232 to be independent of any particular application type. More simply stated, the configuration process 232, in some embodiments, may operate to configure virtually any application type in the configuration workspace.

The configuration process 232 may further be configured to determine one or more configuration packages to instantiate in the configuration workspace 228. Configuration packages, in some embodiments, may include one or a set of configuration settings to enable or disable certain capabilities of the application. Configuration packages, as mentioned above, may be linked to adaptation catalog 214 entries and rules associated with adaptation catalog entries. Thus, the configuration process 232 queries the scoping information in the scoping input database 226 to identify configuration packages to instantiate. Thus, the configuration process 232 typically makes technical application configuration decisions while it executes without requiring further input from a user.

In some embodiments, two or more of the configuration packages identified for deployment by the configuration process 232 may have conflicting configuration settings. Such conflicts can be handled in several ways. In one embodiment, the conflicts may be handled and corrected according to a rule associated with an adaptation catalog 214 entry. Such a rule may be defined to specify how the configuration process 232 will resolve the conflict while populating the configuration tables in the configuration workspace 228. In other embodiments, configuration packages may include an associated rule that is applied by the configuration process 232 to identify conflicting configuration settings and how to resolve an identified conflict. In yet further embodiments, the configuration process 232 may identify conflicting configuration settings when two configuration packages attempt to modify the same configuration setting in a conflicting manner. In such instances, a conflict notice may be provided to one or more individuals. Another embodiment includes two or more of these solutions for handling conflicting configuration settings. However, if conflicts still exist after the configuration process completes its execution, a user may utilize the fine tuning application 234, or directly modify the configuration tables in the configuration workspace 228, to resolve the conflicts.

In some embodiments, the configuration package repository 224 may be stored within the content repository 222. The content repository 222 typically further stores definitions of report layouts, forms, user interfaces, communication specifications, documentation, and other content that can be used in an application when deployed. A communication specification may include an XML schema, an EDI schema and connectivity information, mappings between file layouts and application data storage mechanisms, such as databases, and other similar communication specifications.

Based on rules associated with adaptation catalog 214 entries and the scoping information, the configuration process 232, in some embodiments, may be configured to further identify content to be deployed. This identified content my either be copied to the configuration workspace 228 or, in some embodiments, a reference may be placed in the configuration workspace 228 that informs the deployment module 230 of content to be deployed.

As mentioned above, the fine tuning application 234 may be utilized to modify configuration settings where conflicts exist between two or more configuration settings. However, the fine tuning application 234 may further be used to modify configuration settings where conflicts do not exist. Fine tuning is commonly helpful to customize the configuration based on specific needs or desires of an enterprise that utilizes, or will utilize, the application under configuration.

The fine tuning application, in some embodiments, provides one or more user interfaces for a user to view and modify the configuration settings. In some embodiments, the one or more user interfaces typically allow a user to drill down to the various configuration settings in a hierarchical manner. The hierarchy may be based on the areas, packages, topics, and options selected for deployment from the adaptation catalog by the deduction engine 212 and utilized by the configuration process 232 to select configuration packages to populate the configuration tables. Such embodiments typically allow a user to view the configuration settings in the context of the intended use of the application. In other embodiments, the user interface may further include a scripting screen, from which a script may be executed to modify configuration settings. In some embodiments, the scripting screen may be configured to operate on scripts encoded in a query language, such as Structured Query Language (“SQL”).

In some embodiments, demonstration data may exist to facilitate the instantiation of a demonstration instance of the application for a sales lead, training session, or other purpose. The demonstration data, in some embodiments, may be linked to one or more configuration packages from the configuration package repository 224. The demonstration data may exists in the content repository 222 and may be copied into a set of application tables in the configuration workspace 228. These tables can typically hold such data as one or more of transactional data, operational data, master data, or other data that can exist in the application when the application is ready for execution or is executed.

Once the demonstration data is copied to the configuration workspace 228, that data may be fine-tuned to more closely match the intended use of the demonstration data. For example, a sales person, or other individual, can fine-tune demonstration data values to more closely match a sales lead's expectations of the application. This fine-tuning may include modifying sales order documents in the demonstration data to include a name, address, and logo of the sales lead's enterprise, or other similar modifications to the demonstration data.

In some embodiments, before the deployment module 230 can deploy the application configuration, the configuration process 232 typically provides verification that the configuration is ready for deployment. In some embodiments, the verification may include a compile-like process that performs one or more checks on the configuration. In some embodiments, the checks typically include a semantic check to ensure all configuration settings conform to a configuration setting semantic specification and a syntax check to ensure all configuration settings conform to a configuration setting syntax specification. This typically includes ensuring all necessary configuration settings have been set. In these, and other embodiments, the checks may also include a foreign key check. A foreign key check typically is performed where a configuration setting of a configuration table refers to a value in another configuration table or other data store relevant to the configuration setting. This may include a check to ensure a user interface definition, or other content type that is referred to a configuration setting does in fact exist and is ready for deployment.

After the application has been configured in the configuration workspace and the demonstration data, if any, is ready, and the configuration process 232, if necessary, has performed its verification process, the configuration may be deployed by the deployment module 230. The deployment module 230 typically deploys configuration settings to a baseline application that has already been instantiated in an application execution environment. In some embodiments, the deployment module may include a configuration setting deployment process, an activation process, and a data deployment process. The configuration setting deployment process typically copies configuration settings from the configuration tables in the configuration workspace 228. The data deployment process may be configured to execute if there is demonstration data in the configuration workspace 228. If there is demonstration data, the data may be copied from the configuration workspace 228 to application tables in the application execution environment. Some embodiments further utilize the activation process.

The activation process, in some such embodiments, may be configured to execute to activate the application in the application execution environment after it has been successfully deployed. In some instances, the activation process may require an activation key, message, code, or other authorization from an activation authority to activate the application. The activation authority may include one or more of a number of individuals or entities. An example of an activation authority may include an entity selling the application to be activated. This activation functionality requiring an activation key or other mechanism may be utilized for several purposes. Some such purposes include allowing the entity selling the application to ensure the application is properly configured, has passed certain testing necessary for the entity to ensure it will meet guaranteed service level agreements or objectives, for billing purposes, or other purposes that can benefit from such an activation process.

In some embodiments, the deployment module 230 may further include a delta deployment process. The delta deployment process is generally relevant only after an application has already been deployed. When an application is deployed, or subsequently modified, the scoping information in the scoping input database 226 may be updated to enable tracking of a current configuration of a deployed application. In embodiments including the delta deployment process, the scoping information may further be tracked on a historical basis to at least allow a view of a current configuration and a modified configuration not yet deployed, if applicable. The delta deployment process may then utilize the historical tracking of the application configuration to identify changes between the current application configuration and the modified configuration not yet deployed. The delta deployment process then typically deploys only the changes to the application configuration.

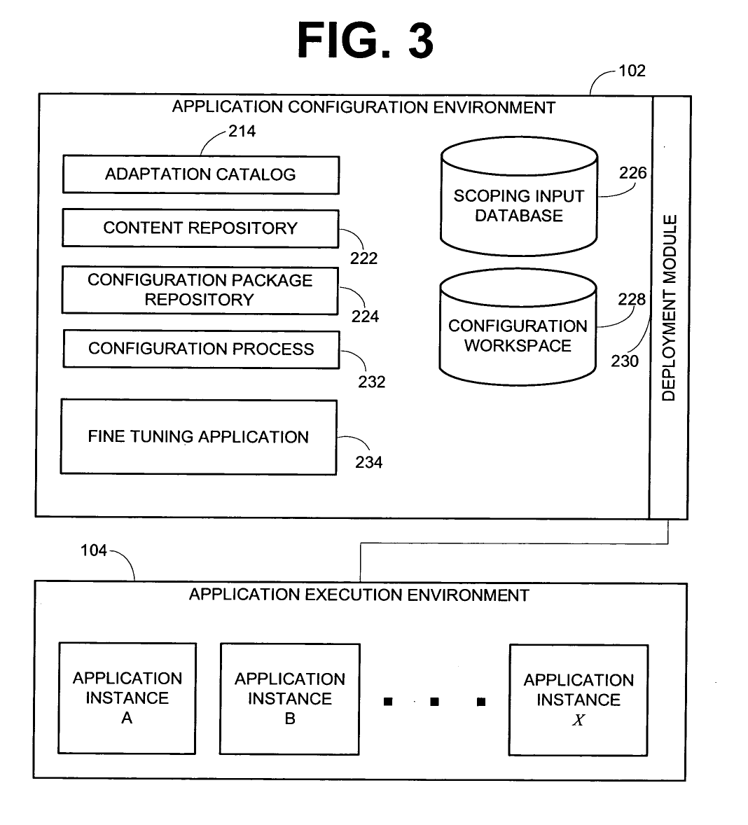

FIG. 3 is a block diagram of a system 300 according to an example embodiment. The system 300 includes the application configuration environment 102 as discussed above with regard to FIG. 1, FIG. 2A, and FIG. 2B. The system 300 further includes an application execution environment 104.

The application execution environment 104 is a data processing environment within which an application, or an application to be deployed, may execute. When deploying an application, the deployment module 230 typically needs to know what application execution environment 104 and what application instance within that environment to deploy to. In embodiments including only one application execution environment 104, the application execution environment 104 may already be known. Similarly, in an application execution environment including only a single application instance, the instance may already be known.

Each instance of the application (i.e., application instances A, B, . . . X) typically includes a set of identical configuration tables which may include distinct configuration settings from one another. In some embodiments, multiple instances of the application may exist such as to provide a development instance, a test instance, and a production instance. In such embodiments where there are multiple application instances, the deployment module 230 may deploy the configuration settings from one of the application instances in the application execution environment 104 to another application in the same or another application execution environment 104. Although the deployment module 230 is illustrated as being a part of the application configuration environment 102, the deployment module 230, in other embodiments, may be a standalone application or a part of another application or process.

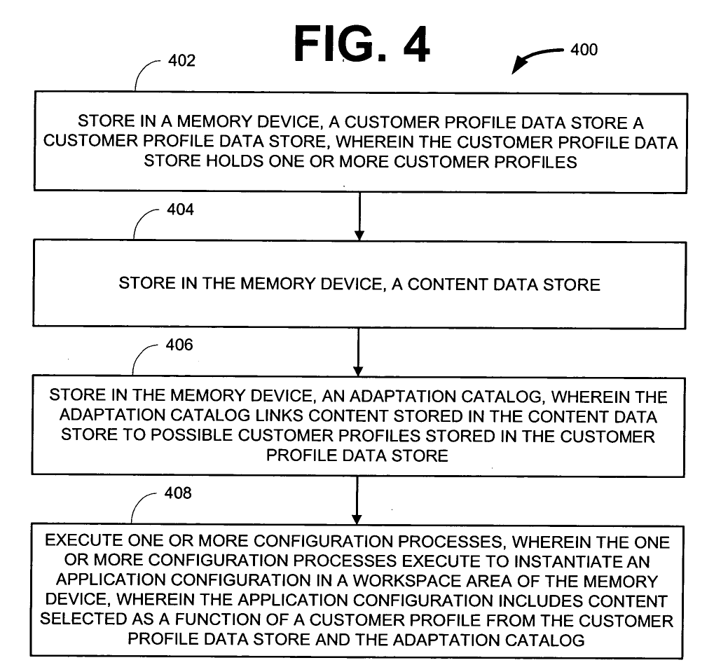

FIG. 4 is a flow diagram of a method 400 according to an example embodiment. The example method 400 includes storing, in a memory device, a scoping input database, wherein the scoping input database holds one or more customer profiles 402 and storing, in the memory device, a content data store 404. The method 400 may further include storing, in the memory device, an adaptation catalog, wherein the adaptation catalog links content stored in the content data store to possible customer profiles stored in the scoping input database 406. The method 400 may also include executing one or more configuration processes, wherein the one or more configuration processes execute to instantiate an application configuration in a workspace area of the memory device, wherein the application configuration includes content selected as a function of a customer profile from the scoping input database and the adaptation catalog 408.

The customer profile data may be received via a configuration application that receives answers to a dynamic set of questions selected from a universe of questions as a function of question answers and the adaptation catalog. Some embodiments of the method 400 may further include receiving application configuration fine-tuning settings. Additional embodiments may also include storing received application configuration fine-tuning settings in a customer profile. Yet another embodiment of the method 400 may include storing a customer profile in a customer profile database.

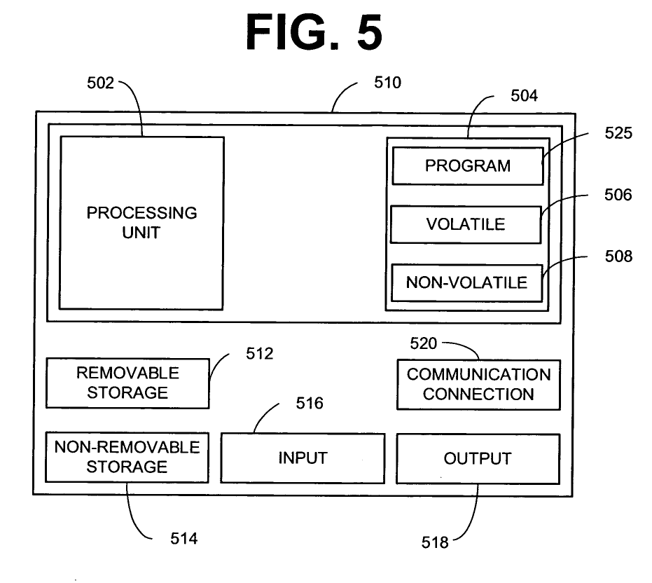

FIG. 5 is a block diagram of a computing system according to an example embodiment. In one embodiment, multiple such computer systems are utilized in a distributed network to implement multiple components in a transaction-based environment. An object-oriented architecture may be used to implement such functions and communicate between the multiple systems and components. One example computing device in the form of a computer 510, may include a processing unit 502, memory 504, removable storage 512, and non-removable storage 514. Memory 504 may include volatile memory 506 and non-volatile memory 508. Computer 510 may include—or have access to a computing environment that includes—a variety of computer-readable media, such as volatile memory 506 and non-volatile memory 508, removable storage 512 and non-removable storage 514. Computer storage typically includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 510 may include or have access to a computing environment that includes input 516, output 518, and a communication connection 520. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 502 of the computer 510. A hard drive, CD-ROM, and RAM are some examples of articles including a computer-readable medium. The term “computer readable medium” is also used to represent carrier waves on which the software is transmitted. For example, a computer program 525 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer 510 to provide generic access controls in a COM based computer network system having multiple users and servers.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A system comprising:
one or more memory devices;
a scoping input database in the one or more memory devices, wherein the scoping input database holds one or more customer profiles;
a content data store in the one or more memory devices;
an adaptation catalog stored in the one or more memory devices, wherein the adaptation catalog links content stored in the content data store to possible customer profiles stored in the scoping input database;
a workspace area in a memory device; and
one or more configuration processes, wherein the one or more configuration processes execute to instantiate an application configuration in the workspace area including content selected as a function of a customer profile from the scoping input database and the adaptation catalog.

2. The system of claim 1, wherein customer profile data is received into the system via a configuration application that receives answers to a dynamic set of questions selected from a universe of questions as a function of question answers and the adaptation catalog.

3. The system of claim 2, further comprising:
a fine-tuning application, wherein the fine-tuning application allows modification of one or more application configuration settings.

4. The system of claim 3, wherein modifications to one or more application configuration settings by the fine-tuning application causes the modified application configuration settings to be stored with a customer profile in the scoping input database.

5. The system of claim 1, wherein a customer profile is further stored in a customer profile database.

6. The system of claim 1, wherein the application configuration instantiated in the workspace environment can be deployed to a runtime environment from which the application can execute.

7. The system of claim 1, wherein the application configuration includes application configuration settings.

8. A method comprising:
storing, in a memory device, a scoping input database, wherein the scoping input database holds one or more customer profiles;
storing, in the memory device, a content data store;
storing, in the memory device, an adaptation catalog, wherein the adaptation catalog links content stored in the content data store to possible customer profiles stored in the scoping input database; and
executing one or more configuration processes, wherein the one or more configuration processes execute to instantiate an application configuration in a workspace area of the memory device, wherein the application configuration includes content selected as a function of a customer profile from the scoping input database and the adaptation catalog.

9. The method of claim 8, wherein customer profile data is received via a configuration application that receives answers to a dynamic set of questions selected from a universe of questions as a function of question answers and the adaptation catalog.

10. The method of claim 9, further comprising:
receiving application configuration fine-tuning settings.

11. The method of claim 10, further comprising:
storing received application configuration fine-tuning settings in a customer profile.

12. The method of claim 8, further comprising:
storing a customer profile in a customer profile database.

13. The method of claim 8, wherein the application configuration instantiated in the workspace environment is deployable to a runtime environment from which the application can execute.

14. The method of claim 8, wherein the application configuration includes application configuration settings.

15. A machine-readable medium, with encoded instructions, which when executed, cause a machine to:
store, in a memory device, a scoping input database, wherein the scoping input database holds one or more customer profiles;
store, in the memory device, a content data store;
store, in the memory device, an adaptation catalog, wherein the adaptation catalog links content stored in the content data store to possible customer profiles stored in the scoping input database; and
execute one or more configuration processes, wherein the one or more configuration processes execute to instantiate an application configuration in a workspace area of the memory device, wherein the application configuration includes content selected as a function of a customer profile from the scoping input database and the adaptation catalog.

16. The machine-readable medium of claim 15, wherein customer profile data is received via a configuration application that receives answers to a dynamic set of questions selected from a universe of questions as a function of question answers and the adaptation catalog.

17. The machine-readable medium of claim 16, wherein the instructions, when further executed, cause the machine to:
receive application configuration fine-tuning settings.

18. The machine-readable medium of claim 17, wherein the instructions, when further executed, cause the machine to:
store received application configuration fine-tuning settings in a customer profile.

19. The machine-readable medium of claim 15, wherein the instructions, when further executed, cause the machine to:
store a customer profile in a customer profile database.

20. The machine-readable medium of claim 15, wherein the application configuration instantiated in the workspace environment is deployable to a runtime environment from which the application can execute.
